(19) United States
(12) Patent Application Publication
(10) Pub. No.: US 2008/0305207 A1
(43) Pub. Date: Dec. 11, 2008

(54) METHOD OF PRODUCING ARTIFICIALLY SWEETENED WINE

(76) Inventors: Charles R. Thomas, Greenwood, IN (US); Michael Cunningham, Spencer, IN (US); Richard Lawson, Indianapolis, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 12/127,314

(22) Filed: May 27, 2008

Related U.S. Application Data
(60) Provisional application No. 60/939,972, filed on May 24, 2007.

(51) Int. Cl. C12G 1/022

(52) U.S. Cl. 426/15

(57) ABSTRACT

A method of producing an artificially sweetened wine is disclosed, comprising the steps of: a) providing a quantity of fermentable material; b) fermenting the material to produce a wine that is substantially dry; and c) adding an artificial sweetener to the wine to produce an artificially sweetened wine.

### CROSS-REFERENCE TO RELATED APPLICATION

This application claims the benefit of U.S. Provisional Patent Application No. 60/939,972, filed May 24, 2007, entitled METHOD OF PRODUCING WINE USING ARTIFICIAL SWEETENERS, which is incorporated herein by reference.

### TECHNICAL FIELD OF THE DISCLOSURE

The present disclosure generally relates to methods for fermenting wine and, more specifically, to a method for producing artificially sweetened wine having an alcohol content of between 9.0% and 13.9%.

### BACKGROUND OF THE DISCLOSURE

Wine is a beverage produced by a process of natural fermentation of fruits, herbs, or vegetables into an aqueous beverage normally containing between 9.0 and 13.9% alcohol. The vast majority of wine is fermented from grapes. Grapes and the resultant wines are exceedingly complex, containing over 1500 different chemical compounds, many of which have not yet been identified. The sensory appeal, the health benefits, and appearance of table wine depends on a normal (9.0-13.9%) alcohol concentration. Therefore, the present disclosure is restricted to wine of 9.0-13.9% alcohol concentration.

As used herein, the term “artificial sweetener” refers to any agent, naturally occurring or manmade, which is added to a 9.0-13.9% alcohol wine for the expressed purpose of creating a sweet or sweeter taste and does not add sugar calories or carbohydrates to the wine.

The average grape for wine production contains hexose sugars, primarily reducing sugars: fructose (levulose), glucose (dextrose); and sucrose, a non-reducing sugar also called “invert sugar.” Fructose and Glucose are present in approximately equal proportions of about 49% each with sucrose about 0.2-1.0%. The total sugars in a ripe grape used for wine production will average 20-24 gm/100 gm or 200-240 gm/liter. When grapes are readied for fermentation into wine, the grapes are crushed (their integrity ruptured to release the sweet juice) and either exposed to naturally occurring yeasts or an inoculum of yeasts is added to allow the yeast organisms to ferment the hexose sugars in the grape to ethyl alcohol and a small percentage (about 1%) of higher alcohol by-products. A starting sugar percentage of 24% will yield about 12.5% ethyl alcohol in the fermented wine. This varies by the sugar types, the yeast, and other relevant conditions impacting this process.

The process of fermentation, is an exothermic enzymatic process performed by any of the yeasts in the group Saccharomyces, which convert hexose sugar into ethyl alcohol, carbon dioxide, and water. This reaction was first described by Joseph-Louis Gay-Lussac in 1810. This so-called Gay-Lussac Reaction also yields a small amount of glycerin (1%) and other higher weighted alcohols and other yeast cellular debris (˜4%). The reaction is as follows:

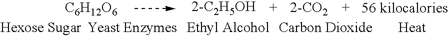

The term “residual sugar” refers to the residual amount of sugars remaining in the wine after fermentation. This represents both unfermented sugars and unfermentable sugars, such as sucrose. This residual sugar, if at or above the level of detection threshold of the person tasting the wine, will cause a sweet sensation to be experienced by the taster. The average normal detection threshold is about 0.8-1.2% residual sugar. Above this level, the sensation of sweetness (perceived sweetness) becomes greater with increasing residual sugar. This is important for the wine taster, who, if the residual sugar amount is below the threshold level, may only perceive fullness or richness in the mouth without realizing there is sweetness present. The sugar is there, nonetheless, and a taster consuming 12 ounces of a wine with a residual sugar of 0.5% would ingest nearly 2 gm of sugar. In drinking a wine that is 5.0% residual sugar (more common), the taster would ingest 20 gm, or 4 teaspoons, of sugar—a possible medical problem for a diabetic person.

Dry wines are wines which have a low percentage of residual sugar, generally 1.5% or less. As used herein, the term “substantially dry” means having 1.5% or less residual sugar. The world's most expensive and celebrated wines are dry, ranging from bone dry (0.0% residual sugar) to 1.0% residual sugar. These are the wines that are purchased by the upper echelon of drinkers as well as wines normally consumed with food. This issue, however, is much more complex than the residual sugar alone. The acidity, the pH, the alcohol content, the tannin content, and their balance all impact on the sensory profile that causes the individual taster to perceive “dry” or “sweet.” In the presently disclosed embodiments, we attempt to use wines that are dry, but the inability to completely ferment some wines to 0.0% residual sugar will still allow some latitude from a sensory standpoint. The majority of these unfermentable sugars are likewise, undigestible in the human body.

The primary consumption of sweet wines by this population (serious wine drinkers) is with dessert wines that are enjoyed as part of the dessert course of a meal. Despite the overwhelming preponderance of advertising of dry wines, more than 50% of the United States population, however, prefer sweet wines. This is partly a genetic partiality to sweet wines and partly cultural. Wine drinkers have been divided by researchers (see, e.g., Liz Thach, Ph.D. and Tim Hanni, M. W., in Vineyard & Winery Management, (January-February, 2008)) into 3 groups of wine preference, primarily on a genetic basis: Tolerant drinkers, Sensitive drinkers, and Hypersensitive drinkers with documented intolerance to acid and tannin. Acid and tannin are both modulated and obtunded by the presence of sugar, explaining much of the abundance of sweet wine drinkers. Further discussion of this phenomenon is not germane to this disclosure.

Sweet wines may be created through any of the following mechanisms or a combination of them: a) incomplete fermentation, where the yeast either die or otherwise become inactive during the fermentation process and fail to completely ferment the sugar; b) the winemaker purposely stops the progress of fermentation by chilling, filtering, centrifuging, or some other method to inactivate the yeast or separate the yeast from the wine sugar so no further fermentation can take place; c) fresh grape juice is added to the wine to add sweetness and/or fruitiness to the wine; d) sugar is added to the wine to sweeten it after fermentation has ceased; e) grape concentrate is added to the wine to sweeten it after fermentation has ceased, or f) the finished wine is blended with another wine that is sweeter, so the final product becomes sweet. Lastly, due to the competitive nature of acid versus sugar, maneuvers such as acid removal will allow the remaining sugar to dominate the tasting profile.

Human nutrition related to wine in particular is complicated, but interesting. When wine or other alcoholic beverages are consumed, 90% of the alcohol enters the blood stream quickly through the small intestine and stomach, and is available for immediate energy. The timing of this entry depends on many factors such as the type of beverage, the concentration of the alcohol, the type and amount of the contents of the stomach, the rapidity of ingestion, fatigue, and other factors that may influence absorption. Even though the calories of a dry wine are quoted at about 10 calories/ounce or 240 calories/24 ounce bottle, there appears to be no assimilation of calories to the moderate consumer. Alcohol is not metabolized through the Kreb (Citric Acid) cycle of human carbohydrate metabolism that requires insulin, therefore alcohol calories are of little or no nutritional significance. Many studies have shown that adding wine to a strict regimen of caloric intake shows no change in weight, fat content, or other parameters in the subject consumer. It appears that the metabolism of alcohol calories is so difficult, that the body expends as much energy to metabolize the alcohol calories as there are calories in the alcohol. This is supported by several medical studies. The net effect of this conundrum is that the only real calories in wine are those from residual sugar.

One important aspect of this issue, however, is that segment of the population with Diabetes Mellitus, i.e. those people with varying degrees of insulin deficiency who cannot produce sufficient endogenous insulin, which is necessary to convert sugar or carbohydrates into energy. Insulin cannot be stored by the body. Diabetes Mellitus is a genetic disease with specific genes responsible for the juvenile and many adult types, but it appears that chronic ingestion of simple sugars to excess and obesity are also responsible for adult-onset Type II Diabetes. Therefore, the elimination or substitution of simple sugars (carbohydrates) can be invaluable in prevention of adult-onset, type II diabetes, the most common form of this disease. Many diabetics prefer sweet wines, but cannot or should not drink them due to the residual sugar content of the wine. Such diabetics, therefore, are not able to enjoy the wine that they would like to drink.

### SUMMARY OF THE DISCLOSED EMBODIMENTS

In one embodiment, method of producing wine using no-calorie sweeteners is disclosed, comprising the steps of: a) providing a quantity of fermentable material; b) fermenting the material to produce a wine having substantially zero percent residual sugar; and c) adding a no-calorie sweetener to the wine.

In another embodiment, a method of producing an artificially sweetened wine is disclosed, comprising the steps of: a) providing a quantity of fermentable material; b) fermenting the material to produce a wine that is substantially dry; and c) adding an artificial sweetener to the wine to produce an artificially sweetened wine.

### BRIEF DESCRIPTION OF THE DRAWINGS

FIG. 1 is a schematic process diagram of a first embodiment process for producing artificially sweetened wine.

### DETAILED DESCRIPTION OF THE VARIOUS EMBODIMENTS

For the purposes of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates are intended to be protected.

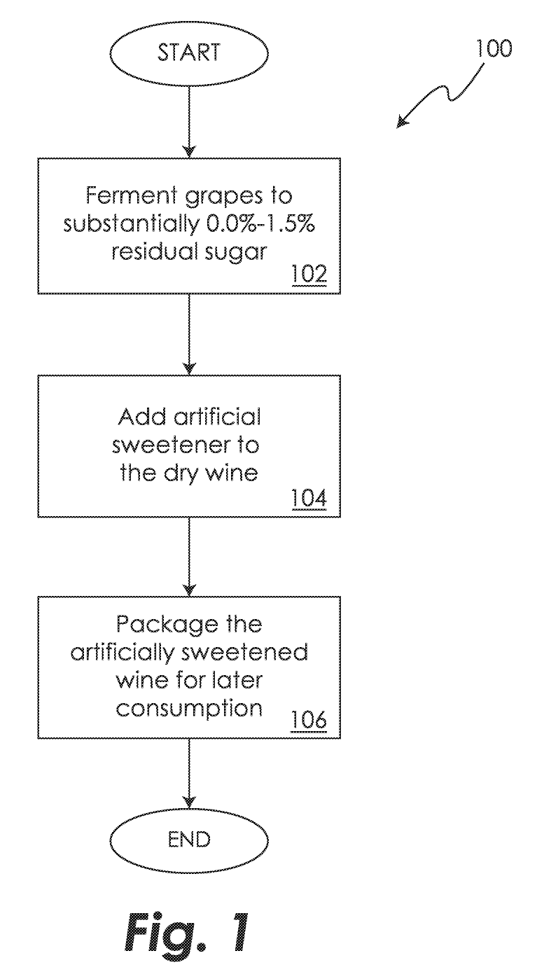

According to the presently disclosed methods, grapes (or other fermentable starting material) are fermented into wine until the resulting wine contains substantially 0.0-1.5% residual sugar (i.e. until the wine is substantially dry), as illustrated at step 102 of the method 100 schematically illustrated in FIG. 1. If the winemaker is successful in fermenting to 0% residual sugar, this guarantees that there are no sugar calories or carbohydrate calories at all in the wine. After fermentation to a substantially dry wine, an artificial sweetener such as, for example, an artificial or naturally occurring no-calorie or low-calorie sweetener, is added to the dry wine at step 104 in order to achieve the desired level of perceived sweetness by the taster. The resulting artificially sweetened wine is then packaged for later consumption at step 106. This resulting artificially sweetened wine has had no sugar calories added to it, yet it is perceived by the taster to be a sweet wine.

### Example 1

In a first embodiment, Sucrulose (available under the brand name SPLENDA® from Tate & Lyle, Inc. of Decatur, Ill.) is used as the sole sweetening agent for the wine. The amount of Sucrulose added to a particular wine will vary depending upon the desired amount of perceived sweetness in the final product. The amount of Sucrulose added to a particular wine will also vary slightly due to differences in acidity levels, buffers, and fruit levels of the wine which would alter the amount of sweetener needed to achieve balanced sweetness. In this embodiment, preferably 0.005-0.020 gm, more preferably 0.012-0.017 gm, and most preferably 0.0140 gm of Sucrulose sweetener is added per 100 ml of wine. Of course, more or less Sucrulose could be added depending upon the desired level of perceived sweetness of the finished wine, but the present inventor believes that this amount generally produces the best result. In a preferred form of this embodiment, the wine is fermented to 0% residual sugar prior to adding the Sucrulose.

### Example 2

In a second embodiment, a blend of approximately 30% Acesulfame-Potassium (available under the brand name SUNETT® from Nutrinova division of Celanese Corporation of Dallas, Tex.) and approximately 70% Sucrulose (available under the brand name SPLENDA® from Tate & Lyle, Inc. of Decatur, Ill.) is used as a blended sweetening agent for the wine. This combination accomplishes two improvements to the formulation of the first embodiment. First, the sweetness of the blend is approximately 30% greater than for Sucrulose alone and is flavor-wise closer to that of dextrose, or table sugar. Secondly, each sweetener appears to subdue the slight aftertaste created by the other, so the net effect is an overall change in the character and a reduction in the intensity of the aftertaste.

The amount of the Acesulfame-Potassium/Sucrulose blend added to a particular wine will vary depending upon the desired amount of perceived sweetness in the final product. The amount of the sweetener blend added to a particular wine will also vary slightly to achieve balanced sweetness, since varying acid levels in the wine influence the perceived sweetness. In this embodiment, preferably 0.010-0.030 gm, more preferably 0.015-0.025 gm, and most preferably 0.0200 gm of the approximately 30% Acesulfame-Potassium/70% Sucrulose sweetener combination is added per 100 ml of wine. Of course, more or less of the sweetener combination could be added depending upon the desired level of perceived sweetness of the finished wine, but the present inventor believes that this amount generally produces the best result. In a preferred form of this embodiment, the wine is fermented to 0% residual sugar prior to adding the approximately 30% Acesulfame-Potassiuml70% Sucrulose sweetener combination.

The sweeteners of both the first and second embodiments have both been shown to be very stable. Testing demonstrates a 3-month, in-bottle testing to be identical in taste with an original sample. The safety of both sweeteners as a food additive has been well-established and documented by the manufacturer, and has additionally been approved for use in beverages by the U.S. Food and Drug Administration.

### Example 3

In the third embodiment, a different sweetening agent is used solely to achieve its effect. This is a sugar alcohol, Erythritol, ((2R,3S)-butane-1,2,3,4-tetrol, manufactured by Cerestar Holding, B. V.) which has a much smaller molecule that permits rapid absorption from the gastrointestinal tract, primarily in the small intestine. Erythritol is a naturally-occurring sugar alcohol, belonging to a group of similar sugar substitutes (including Sorbitol, Mannitol, and Xylitol) called Polyols. Over 90% of the Erythritol is absorbed directly into the blood stream, unaltered, providing its sweetening effect. Being a small molecule and a sugar alcohol, it is not metabolized, but 90% is excreted intact through the kidney and liver. In addition, there is no perception of an aftertaste with this compound. The amount used is approximately preferably 5.0-15.0% by weight, more preferably 7.5-12.5% by weight, and most preferably 10% by weight, which when added to a standard, completely dry (ie., no residual sugar) wine will give a perceived sweetness profile equivilant to a wine of about 6.0-7.0% sugar. There are no known side effects, the product is stable, well-tolerated, and tastes like sugar. It has a glycemic index of 0 and is certified by the U.S. F. D. A. as 0.0 calories/gm %. It bears an FDA GRAS approval as a sugar substitute and for use in beverages.

There are several other sweeteners, both discovered and marketed and some undiscovered, that may be used in the presently disclosed methods instead of the three embodiments detailed above. These are found in 4 categories: (1) artificial, no-calorie sweeteners, (2) artificial, low-calorie sweeteners, (3) naturally occurring, no-calorie sweeteners, and (4) naturally occurring, low-calorie sweeteners. These sweeteners may be used alone or in combination with one another. These include (followed in parentheses by their producer):

Artificial, No-Calorie Sweeteners—

Acesulfame potassium (Nitrinova, Inc.)

Alitame (Pfizer, Inc.)

Aspartyl phenylalanine (The Nutrasweet Co.)

Dihydrochalcones

Litesse II Solution (Danisco Sweeteners)

Lou Han Guo (Full Spectrum Foods, Inc.)

Neotame (The Nutrasweet Co.)

Stevia (Cargill, Inc.)

Saccharin

Sodium and Calcium Cyclamates (Zhong Hua Fang Da (H.K.) Ltd.)

Stevia (Longma Inc.)

Shugr (Swiss Research)

Trucina Dulcem (Nutrilab Corp.)

Artificial, Low-Calorie Sweeteners—

Trehalose (Cerestar USA & Cargill, Inc.)

Naturally Occurring, No-Calorie Sweeteners—

Erythritol (Cerestar USA & Cargill, Inc.)

Naturally Occurring, Low-Calorie Sweeteners—

Arabitol

Ethyl Maltol (Westco Chemicals, inc.)

Isomalt (Paltninit)

Lactitol (Danisco Sweeteners)

Mannitol

Sorbitol

Talin (Overseal Color, Inc.)

Xylitol (Tagatose SweetGredients GmbH & Co.)

In tasting evaluations, a White (100% Muscat Canelli), a Blush (Chenin Blanc & Rubired) and a Red (Rubired) using the above-recited artificial sweeteners were all received well. It is believed that the popularity of these wines will include not only those sweet wine drinkers in the Low Carbohydrate Diet group, those who are following a Low Calorie Diet, but, most importantly, those customers with Diabetic Mellitus who prefer sweet wine.

It will be appreciated in view of the disclosure above that the methods of the present invention are not limited to the three disclosed no-calorie sweeteners. The scope of the invention includes the addition of any artificial or naturally occurring sweetener to a wine that has been fermented to a substantially dry state, such that essentially no sugar calories or carbohydrate calories are contained in the finished, sweetened wine. It is important to also recognize that these wines will all contain the amount of alcohol (e.g., 9.0-13.9% by volume) necessary to preserve the sensory characteristics of a normal table wine.

In view of the foregoing, and while the invention has been illustrated and described in detail in the drawings and foregoing description, the same is to be considered as illustrative and not restrictive in character, it being understood that only the preferred embodiments have been shown and described and that all changes and modifications that come within the spirit of the invention are desired to be protected.

What is claimed:

1. A method of producing wine using no-calorie sweeteners, comprising the steps of:
a) providing a quantity of fermentable material;
b) fermenting the material to produce a wine having substantially zero percent residual sugar; and
c) adding a no-calorie sweetener to the wine to produce an artificially sweetened wine.

2. The method of claim 1, wherein the material comprises grapes.

3. The method of claim 1, wherein the no-calorie sweetener is an artificial sweetener.

4. The method of claim 3, wherein the no-calorie sweetener comprises Sucrulose.

5. The method of claim 4, wherein approximately 0.0140 gm of Sucrulose is added per 100 ml of wine.

6. The method of claim 3, wherein the no-calorie sweetener comprises a blend of Acesulfame-Potassium and Sucrulose.

7. The method of claim 6, wherein the no-calorie sweetener comprises a blend of approximately 30% Acesulfame-Potassium and approximately 70% Sucrulose.

8. The method of claim 7, wherein approximately 0.0200 gm of a blend of approximately 30% Acesulfame-Potassium and approximately 70% Sucrulose is added per 100 ml of wine.

9. The method of claim 1, wherein the no-calorie sweetener is a naturally occurring sweetener.

10. The method of claim 9, wherein the no-calorie sweetener comprises Erythritol.

11. The method of claim 10, wherein approximately 10% by weight of Erythritol is added to the wine.

12. The method of claim 1, further comprising the step of:
d) packaging the artificially sweetened wine for later consumption.

13. A method of producing an artificially sweetened wine, comprising the steps of:
a) providing a quantity of fermentable material;
b) fermenting the material to produce a wine that is substantially dry; and
c) adding an artificial sweetener to the wine to produce an artificially sweetened wine.

14. The method of claim 13, wherein the material comprises grapes.

15. The method of claim 13, wherein the artificial sweetener is a no-calorie sweetener.

16. The method of claim 15, wherein the no-calorie sweetener comprises Sucrulose.

17. The method of claim 16, wherein approximately 0.0140 gm of Sucrulose is added per 100 ml of wine.

18. The method of claim 15, wherein the no-calorie sweetener comprises a blend of Acesulfame-Potassium and Sucrulose.

19. The method of claim 18, wherein the no-calorie sweetener comprises a blend of approximately 30% Acesulfame-Potassium and approximately 70% Sucrulose.

20. The method of claim 19, wherein approximately 0.0200 gm of a blend of approximately 30% Acesulfame-Potassium and approximately 70% Sucrulose is added per 100 ml of wine.

21. The method of claim 13, wherein the artificial sweetener is a naturally occurring no-calorie sweetener.

22. The method of claim 21, wherein the no-calorie sweetener comprises Erythritol.

23. The method of claim 22, wherein approximately 10% by weight of Erythritol is added to the wine.

24. The method of claim 13, further comprising the step of:
d) packaging the artificially sweetened wine for later consumption.
